(19) United States
(12) Patent Application Publication
(10) Pub. No.: US 2021/0031239 A1
(43) Pub. Date: Feb. 4, 2021

(54) SYSTEMS AND METHODS OF HANDLING TUBERS

(71) Applicant: HBV Production BV, Eindhoven (NL)

(72) Inventor: MARK Verschuren, Eindhoven (NL)

(21) Appl. No.: 16/966,154

(22) PCT Filed: Feb. 2, 2018
(86) PCT No.: PCT/EP2018/052718

§ 371 Date: Jul. 30, 2020

(51) Int. Cl. B07C 5/10; B65G 47/46; B65G 47/88; B65G 43/08; G06T 7/00

(52) U.S. Cl. CPC B07C 5/10; B65G 47/46; B65G 47/88; G06T 2207/30128; G06T 7/0004; B65G 2201/0202; B65G 2203/041; B65G 43/08

(57) ABSTRACT

A system for handling tubers comprises at least one camera; at least one conveyor for displacing said tubers relative to said camera; a processor for processing images obtained from said camera to determine at least one value representative of said tubers' diameter and at least one value representative of said tubers' length; an actuator for directing tubers below a pre-determined diameter d₁ towards a first category of tubers and selecting tubers above said pre-determined diameter d₁ for further processing; said actuator or a further actuator being configured to further process said tubers by either accepting said tubers into a target category when said tubers' length is above a variable length Lₓ or directing said tubers for further processing when said tubers' length is below said variable length Lₓ; and said processor being configured to assess the average length of a batch of tubers and dynamically adjust said variable length Lₓ; whereby a pre-determined average length L₁ of tubers for a pre-determined number of tubers is maintained for said target category.

### TECHNICAL FIELD

Embodiments concern systems and methods of handling tubers eg. potatoes, parsnips, carrots and similar food produce.

### BACKGROUND TO THE INVENTION

Aspects of the invention concern tubers which are typically elongate vegetables such as potatoes, carrots, parsnips etc which generally have a higher length than diameter and which vary in size and dimensions, dependent upon numerous factors such as origin, variety, species, weather, condition, diseases, abnormalities, bumps, notches, skin discoloration, various colours and potential defects. Traditionally, the sorting, and the sampling of tubers has therefore presented a significant challenge. One approach has relied on a succession of meshes through which the tubers are fed. Meshes of this kind will provide the possibility for certain undersized tubers of passing through. Whilst this allows sorting in accordance predominantly with the diameter of a tuber, and allows relatively large diameter tubers from being directed towards a target category suitable for frying, many lengthy tubers are rejected which would be ideal for further processing into for example French fries where a certain length is required for efficient processing. A further drawback of a mesh-based system is the potential damage which arises as the tubers fall against the surfaces of conveyors as mesh systems generally rely on gravity to feed tubers through the sorting process. In an industry where any reduction in waste or potential damage signifies a considerable step forward, the invention in at least one aspect seeks to provide a system which achieves a higher percentage of target categories for improving the efficient processing of tubers into French fries and the like.

Another drawback is due to the inherent complexity of tubers that sampling has been the preserve of human experts alone who would through accumulated knowledge provide an assessment of a sample. No sampler is currently available which provides repeatable low volume assessments of pre-determined characteristics of the kind arising in tubers. Furthermore, human sampling is inherently limited, time consuming and not suitable for standardisation. Aspects of the invention seek to address this issue in a particularly efficient manner.

Grading of complex products is an essential part of efficient processing of these complex natural products. Any improvement in the accuracy of the grading and sorting processes will have particularly significant consequences when considering the high volumes associated with the mass processing of these products. Aspects of the invention seek to improve grading and/or sorting of tubers for one or more of the characteristics associated with tubers.

### SUMMARY OF THE INVENTION

In a first broad aspect, the invention provides a method of handling tubers comprising the steps of providing at least one camera; providing at least one conveyor for displacing the tubers relative to the camera; processing images obtained from the camera to determine at least one value representative of the tubers' diameter and at least one value representative of the tubers' length; directing tubers below a pre-determined diameter d₁ towards a first category of tubers and selecting tubers above the pre-determined diameter d₁ for further processing; further processing said tubers by either accepting said tubers into a target category when said tubers' length is above a variable length Lₓ or directing the tubers for further processing when the tubers' length is below the variable length Lₓ; assessing the average length of a batch of tubers and dynamically adjusting the variable length Lₓ; whereby a pre-determined average length L₁ of tubers for a pre-determined number of tubers may be maintained for the target category. This is particularly advantageous in terms of efficiently sorting of tubers for the complex requirements of French Fry processing, potato wedge processing and flake processing.

In a subsidiary aspect, the method comprises the further step of assessing the tubers which are not selected for the target category against a pre-determined length L₂ and directing the tubers either to a second category when the tubers are above the pre-determined length L₂ or to the first category when the tubers are above the pre-determined length L₂. This configuration is particularly advantageous in the efficient provision of tubers suitable for wedge production.

In a further subsidiary aspect, the method further comprises the step of rotating the tubers relative to the camera. This allows a multi-dimensional assessment to be obtained and ensures the determination of sufficient values of length and diameter to overcome the inherent complexities associated in the very large variations in shape and size associated in natural products of the kind in question.

In a further subsidiary aspect, the tubers are imaged as a batch of tubers; the batch of tubers being greater than 50, or greater than 75 or greater than 95. This allows an efficient on-going sizing process to be achieved without requiring necessarily constant dynamic adjustment of Lₓ as it may be adjusted for each batch at a time only.

In a further subsidiary aspect, the variable length is adjusted after a batch of tubers; whereby the average length of a sequence of batches may be maintained for the target category of tubers.

In a further aspect, the invention provides a system for handling tubers comprising at least one camera; at least one conveyor for displacing the tubers relative to the camera; a processor for processing images obtained from the camera to determine at least one value representative of the tubers' diameter and at least one value representative of the tubers' length; an actuator for directing tubers below a pre-determined diameter d₁ towards a first category of tubers and selecting tubers above the pre-determined diameter d₁ for further processing; the actuator or a further actuator being configured to further process the tubers by either accepting the tubers into a target category when the tubers' length is above a variable length Lₓ or directing the tubers for further processing when the tubers' length is below the variable length Lₓ; and the processor being configured to assess the average length of a batch of tubers and dynamically adjust the variable length Lₓ; whereby a pre-determined average length L₁ of tubers for a pre-determined number of tubers is maintained for the target category.

In a subsidiary aspect, the system further comprises a processor for assessing the tubers which are not selected for the target category against a pre-determined length L₂ and an actuator configured to direct the tubers either to a second category when the tubers are above the pre-determined length L₂ or to the first category when the tubers are above the pre-determined length L₂.

In a further subsidiary aspect, the system further comprises a conveyor which rotates the tubers relative to the camera.

In a further subsidiary aspect, the processor and the camera are configured to image tubers as a batch of tubers; the batch of tubers being greater than 50, or greater than 75 or greater than 95.

In a further subsidiary aspect, the processor and the actuator are configured to adjust the variable length after a batch of tubers; whereby the average length of a sequence of batches may be maintained for the target category of tubers.

In a further subsidiary aspect, the system incorporates a plurality of discharge routes corresponding to the categories and at least one actuator comprising one or more actuatable fingers for individually directing a tuber to a determined discharge route.

In a further aspect, the method of sampling a batch of tubers comprises the steps of providing at least one camera; providing at least one conveyor for displacing the tubers relative to the camera; obtaining images of the tubers from the camera; determining a number of pixels of a particular characteristic; and determining a percentage of the total number of pixels of a tuber in an image which corresponds to the particular characteristic.

This provides repeatable and reliable sampling of produce without the drawbacks of conventional error prone human assessment whilst also achieving improved processing efficiency.

In a subsidiary aspect, the method further comprises the step of obtaining a plurality of images of the tuber whilst the tuber is being rotated; and recording the highest percentage of the total number of pixels in an image which corresponds to the particular characteristic. This allows particularly acute conditions to be spotted and analysed which permits efficient and reliable comparisons between different samples.

In a further subsidiary aspect, the characteristic includes a colour representative of one or more of the following: green, spots, discolouration, and rot. The advantageous of efficient assessment and reliable comparisons are particularly present for this selection of characteristics.

In a further subsidiary aspect, the characteristic includes a colour in combination with a shape of an area representative of one or more of the following: a green shape, mechanical damage, a scab, a crack, a black dot, a black scurf, a silver scurf, a skin spot. This also allows accurate and reliable comparisons of more complex conditions present on these highly complex tubers.

In a further subsidiary aspect, the method further comprises the steps of determining at least one value representative of a tuber's diameter and at least one value representative of a tuber's length. These characteristics provide a particularly efficient approach to reliable and repeatable sampling.

In a further subsidiary aspect, the method further comprises the steps of providing a record of the percentages and values obtained for a batch of tubers. This allows relative comparisons to be obtained for a plurality of disparate batches and to be able to compare several of these samples.

In a further subsidiary aspect, the method further comprises the steps of exporting the percentages and values. In certain embodiments, this allows remote assessment either in real time or at a differed time as selected by an operator.

In a further broad aspect, the invention provides a sampling system for assessing a batch of tubers comprising at least one camera; at least one conveyor for displacing the tubers relative to the camera; a processor for obtaining images of the tubers from the camera and determining a number of pixels of a particular characteristic; the processor being configured to determine a percentage of the total number of pixels of the tuber in an image which corresponds to the characteristic.

In a further subsidiary aspect, the camera is configured to obtain a plurality of images of a tuber whilst the tuber is being rotated; and the processor is configured to record the highest percentage of the total number of pixels in an image which corresponds to a particular characteristic.

In a further subsidiary aspect, the characteristic includes a colour representative of one or more of the following: green, spots, discolouration, and rot.

In a further subsidiary aspect, the characteristic includes a colour in combination with a shape of an area representative of one or more of the following: a green shape, mechanical damage, a scab, a crack, a black dot, a black scurf, a silver scurf, a skin spot.

In a further subsidiary aspect, the processor is configured to determine at least one value representative of a tuber's diameter and at least one value representative of a tuber's length.

In a further subsidiary aspect, the system further comprises a data storage for recording percentages and values obtained for a batch of tubers.

In a further subsidiary aspect, the sampling system further comprises a communication interface for exporting the percentages and values.

In a further subsidiary aspect, the sampling system further comprising an inlet suitable for receiving a batch of less than 50 kilograms of tubers and an outlet suitable for returning the entire batch following its assessment without any sorting taking place.

In a further subsidiary aspect, the sampling system further comprises an assessment area and a single access portal through which a batch sequentially enters and exits the assessment area.

In a further broad aspect, the sorting machine comprises at least one camera; at least one conveyor for displacing the tubers relative to the camera; a processor for obtaining images of the tubers from the camera and determining a number of pixels of at least one characteristic; the processor being configured to determine a percentage of the total number of pixels of the tuber in an image which corresponds to the characteristic; a plurality of discharge routes; and at least one actuator for individually directing a tuber to a determined discharge route dependent upon its determined percentage. This allows efficient and high-volume sorting.

In a further subsidiary aspect, the actuator comprises one or more actuatable fingers for individually directing a tuber to a determined discharge route. This configuration is particularly advantageous in terms of its efficiency when compared to prior art propositions.

In a further subsidiary aspect, the sorting machine comprises a conveyor which rotates the tubers; whereby at least 5 images of a tuber are obtained.

In a further subsidiary aspect, the sorting machine further comprises strobe lighting and means for synchronising the lighting with the camera. This provides improved accuracy of assessment.

In a further subsidiary aspect, the lighting has a variable wavelength which varies dependent upon said characteristic. This further improves the accuracy of the determination of the particular characteristic being assessed.

In a further subsidiary aspect, the camera is a multi-wavelength camera.

In a further subsidiary aspect, the strobe lighting comprises light emitting diodes.

In a further subsidiary aspect, the strobe lighting and the camera are configured to operate in the infrared spectrum.

In a further subsidiary aspect, the characteristic is selected from one or more of the following: rot, skin discolouration, shape, texture, green, colour, colour of the ends of tubers, spot, cut, crack, length, diameter and/or square mesh.

### BRIEF DESCRIPTION OF THE FIGURES

FIG. 1 shows a flow diagram of a first embodiment of a system for handling tubers.

FIG. 2 illustrates the pixel processing in a second embodiment of a system for handling tubers.

FIG. 3 is a block diagram of an embodiment of a sampling apparatus.

FIG. 4 is a block diagram of an embodiment of a sorting apparatus.

### DETAILED DESCRIPTION OF THE FIGURES

### Sizing for Average Length

In a first embodiment, the system relies on the feeding of tubers on roller conveyors so that a succession of tubers are held by adjacent rollers in the valleys provided between adjacent rollers. These conveyors are of known kind and allow the handling of tubers with minimal damage through the sorting system or apparatus. The conveyor displaces the tubers into an assessment area which assesses simultaneously a plurality of rows in which tubers are located for assessment. The assessment chamber is preferably enclosed in order to allow improved and bespoke lighting to be present therein, and for improved cameras to record multiple images of the individual tubers within the assessment chamber as the tubers are rotated about their longitudinal axis. Preferably 10 or more and optionally up to 16 images of the surface of each individual tuber is obtained in the assessment chamber.

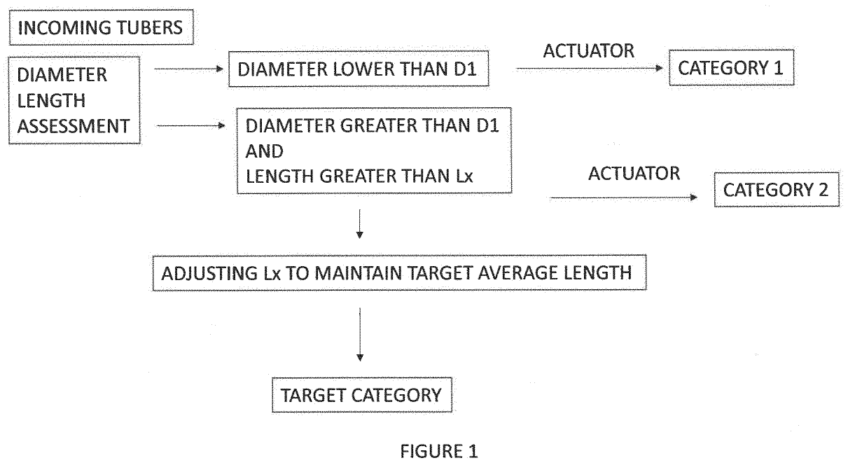

In certain embodiments, the number of images may be 5 or more. The rollers of the conveyor which present the tubers to the various cameras may be configured to achieve complete 360° rotation of a tuber. Each individual tuber is provided with a temporary reference number which may be an alphanumeric code. A processor is provided for processing images obtained from the cameras to determine at least one value representative of a tuber's diameter and at least one value representative of the tuber's length. One option provides maximum axial length value whilst another measure provides a maximum diameter value. Once these various dimensional values are obtained, an assessment takes place which provides feedback to an actuator which may take the form of individually displaceable fingers which may either allow the passage of a tuber into a particular category or may direct a tuber towards a different discharge route where tubers of a second or third category are directed. A processing module may be configured to cause the actuator to direct tubers of a diameter lower than D₁, for example any tuber with a diameter less than 35 mm may be identified as unsuitable for a target category e.g. the French fries category, or even unsuitable for the potato wedge category and may therefore be directed towards a so-called flake category for further processing. An embodiment of the overall process for sizing by average length is provided in FIG. 1

In addition to the assessment with regard to diameter, the processor will identify which tubers are suitable for either the potato wedge category or the French fries category. In order to further provide a target length, a module processes the values of, for example, a batch of 100 tubers in order to determine an average length for a particular batch, and thereafter provide instructions to the actuators to allow the passage of tubers to the target category only if the length of a tuber is greater than Lₓ. As the sequence of batches is processed in order to achieve a particular target average length, subsequent batches of 100 either accept a larger amount of lower diameter tubers or reject a higher amount of these in order to bring the target average length within an acceptable value. For example, after 3,000 tubers a succession of 30 batches of 100 will have been processed potentially with the acceptable length Lₓ being adjusted after each batch in order to maintain the target average length at a particular value. This may be illustrated by providing an Lₓ value of 65 mm for each individual tuber so that for a batch of 100 tubers any above this value is presented to the target French fry category provided the ongoing average is maintained at a length of 90 mm. If the value is not converging towards the desirable 90 mm length after each successive batch, Lₓ may be varied in order to retain the delivery of tubers of an average length of 90 mm. This may also at times involve the rejection of particularly long tubers. In order to cater for this possibility, the process may be configured to assess tubers which are not selected for the target category against a predetermined length L₂ which may, for example, be 85 mm. If L₂ is greater than 85 mm, an actuator may be configured to direct the tubers to the flake category as these may not be suitable for the potato wedge category.

The segmentation of the overall number of processed tubers into individual batches, and the adjustment of the acceptable length of tubers for each subsequent batch is particularly important in order to obtain and maintain the desirable or target lengths. The batch size may be adjusted and may be greater than 50, or greater than 75, or greater than 95, and may be lower than 150. In the preferred embodiment described above, the batch size may be of 100 tubers in order to further simplify the processing required to illustrated how Lₓ may be adjusted to maintain a target average length. In other words, once the tubers comply with a minimum absolute diameter and a minimum absolute length, the tubers are analysed for average length on a rolling average, and the shortest tubers are selectively moved from the large grade down to the medium grade, to maintain a pre-set average for the large grade, which is the target size for French fries. The large grade may also have additional requirements which may be applied, such as quality characteristics. Further details with regard to quality characteristics will be provided in subsequent embodiments.

Embodiments of the invention have the possibility of combining the average length sizing described in the preceding embodiment and the sorting as per additional characteristics as detailed in subsequent embodiments.

### Sampling Systems

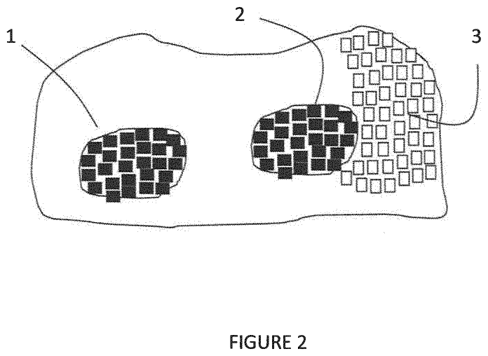

Processing suitability of tubers is dependent on size and surface quality. Processing suitability is typically carried out by human sorters assessing the surface quality and size of, say, a 15 kg sample against predetermined criteria of surface quality and size. There is a need to provide a system which achieves consistent sampling results and is not reliant on human assessment on its own. In this embodiment, a sampling apparatus is presented where a conveyor is provided, of a size which is suitable to provide an intake of 10 to 15 kilograms of product for assessment. This conveyor may take the form of a series of rollers in order to allow the tubers to be transported into an assessment area. In the assessment area, the tubers are rotated about their longitudinal axes in order to obtain multiple pictures or images of one or more tubers. The assessment area may be provided in an assessment chamber where strobe lighting and infra-red cameras are configured to provide appropriate lighting and images for further processing. A processor is operatively connected to the sampling apparatus to synchronise the strobe lighting and the camera. A local data store may be provided. Alternatively, a remote data store or processor may be envisaged. Once the data or information is obtained from the sample of 10 to 15 kilograms of tubers, these may be discharged from the sampling apparatus, either by employing the same conveyors to drive the displacement out of the same access portal, or into a bespoke separate exit route. By employing the same input and output portal to the assessment area, the sampling apparatus may be a particularly compact machine with all the components required for sampling alone. FIG. 2 illustrates the innovative approach that may be employed for assessing a batch of tubers. If, for example, multiple images of a tuber are obtained by the cameras, the images may be assessed to determine the number of pixels, such as the pixels in areas 1 and 2 which may be representative of rot patches 1 and 2. The number of rot patches in these areas are then added together in order to determine an overall number of brown-black pixels corresponding to rot, and are then further processed against the total number of pixels 3 of the tuber. This would allow a percentage to be determined representative of a particular level of rot in a particular view of the tuber. In an embodiment, at least 10 images if not 16 images of the kind shown in FIG. 2 are obtained. In certain embodiments, at least 5 images are processed. In order to provide an accurate measure and a consistent measure of the percentage of rot in a particular potato, only the view with the greatest percentage of rot pixels versus the total number of pixels is retained for comparison purposes. This approach is applied to each one of the tubers in the sample batch in order to determine an overall spread of maximum percentages of rot pixels relative to the pixels of the tuber as a whole. Whilst this embodiment illustrates the assessment of the rot characteristic, the sampling apparatus may be configured to also assess images for green levels to determine the green level as a percentage of the total number of pixels of a tuber.

These assessments are pursued for further characteristics dependent on predetermined pixel colours representative of characteristics such as spots, discolouration and defects. In addition to counting and categorising the pixels and assessing them relative to the total number of pixels, the processor is also configured to assess the relative sizes and configurations of areas containing defects such as scaring and mechanical damage. Scaring for example may be defined as a particularly narrow and relatively long area of a particular colour. A module may therefore determine number of areas falling within pre-determined areas with relatively elongate shapes for example X pixels in width and Y pixels in length etc.

When assessing individual properties, the cameras and the strobe lighting may be configured to vary their operative wave lengths. In order to enhance the assessment of green, a particularly advantageous aspect is to employ an infra-red lighting and camera setup. The processor may be configured to adjust in accordance with the characteristic which is being assessed for advantageous determination of the property.

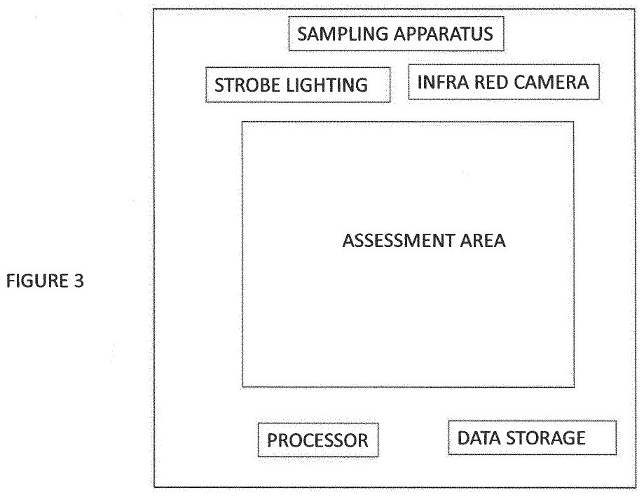

FIG. 3 illustrates the sampling apparatus in accordance with an embodiment of the invention comprising a processor, data storage, an assessment area, strobe lighting, and an infra-red camera.

### Quality Grading

The percentage assessment of the sampling apparatus may also be particularly advantageous when applied to a sorting apparatus. In this embodiment, a sorting apparatus is provided in order to present a plurality of tubers or a batch of tubers to an assessment area which may be in an assessment chamber of the kind described in the previous sections. In the assessment chamber appropriate strobe lighting and infra-red cameras may be positioned to assess tubers as they are rotated about their longitudinal axes. The conveyors may typically employ rollers to retain the tubers in individual valleys for assessment. Multiple images are obtained of individual tubers as they rotate. These images may be assessed as per their pixel characteristics as described previously, and thereafter the processor may be operatively configured to instruct actuators such as an array of fingers which are individually displaceable, to direct tubers towards a plurality of discharge routes. The sorting apparatus may be set to sort the tubers dependent upon predetermined characteristics such as rot, skin discolouration, shape, texture, green levels, colours, colour of the ends, total spot surface areas, mechanical damage, cuts/cracks, minimum and maximum length, minimum and maximum square mesh.

In certain embodiments, a roller conveyor transports tubers under a row of CCD (Charge-Coupled Device) array cameras. Whilst in preferred embodiment CCD cameras are envisaged in alternative embodiments CMOS (complementary metal-oxide-semiconductor) cameras or other such cameras may be employed. An encoder may be driven from a chain wheel to drive the roller conveyor. In the assessment area, the tubers may be aligned in the valleys across the machine. This allows, for example, rows of tubers to be assessed simultaneously. A valley position may be tracked relative to an index pulse on an encoder. The potato or tuber positions may be identified in the valley and tracked through multiple pictures taken at fixed intervals of encoder incremental pulses. Individual tubers are tracked and sorted as single objects with a number of views. In preferred embodiments, there are no dividers between neighbouring cameras so that some tubers may be imaged by adjacent cameras part under each camera. The two parts of a tuber may be analysed in order to provide quality classification as if under one camera. In such applications, the percentage of a particular property such as green spots or areas, may be assessed against the total pixels of each tuber in a particular view. In a further embodiment, the rotation of the tubers is stopped in the last view and the tubers are carried without rotation to the end of a conveyor. A fixed distance encoder ensures that tubers are ejected by fingers as these are activated to direct the tubers to a correct grade destination dependent upon the assessment criteria entered.

In order to further improve the assessment area, a blue background is provided. On occasion, adjacent tubers are in physical contact with each other. In order to isolate individual tubers for appropriate individual assessment, an algorithm determines when several tubers appear to be in contact with one another due to their aspect ratios, and separates these mathematically. This may be carried out by determining the slope of the curvature of particular portions of a tuber which do not generally occur in nature, as a likely location for a digital separation of adjacent tubers. Each image of each tuber may be analysed, for a number of surface features and a numerical score is assigned to each view. The worst, and potentially highest scoring feature may be used to tag the tuber as being in a particular grade. This may be similar to the high percentage employed in the sampling apparatus. A tuber classed as appropriately sized, or a class 2 for spot and class 3 for green, may be sent to the lowest grade, i.e. grade 3. In preferred embodiments, the sorting apparatus may be configured to carry out eight logical separations and three physical separations of quality and size.

Rolling statistics may be presented by tuber count of the last 250 potatoes showing the grading information in a user display.

Images can be collected of tubers in each grade, randomly, or by grading feature to help the operator tune the settings for best performance. Whilst data storage is available, embodiments envisage exporting data to remote locations.

Remote entry of settings may be provided using MODBUS TCP/IP and a Red Lion DSPLE interface.

In certain embodiments, the system employs four channel GigE connected RGB+IR JAI cameras for vision, one per 500 mm of width of transport.

An air valve network communication may be provided.

A digital I/O board may be used to trigger the cameras and other data.

A 2 Quad port 1 GHz Ethernet board is employed to communicate to the cameras.

A bespoke built industrial computer running Windows-embedded standard 7P is used to host software.

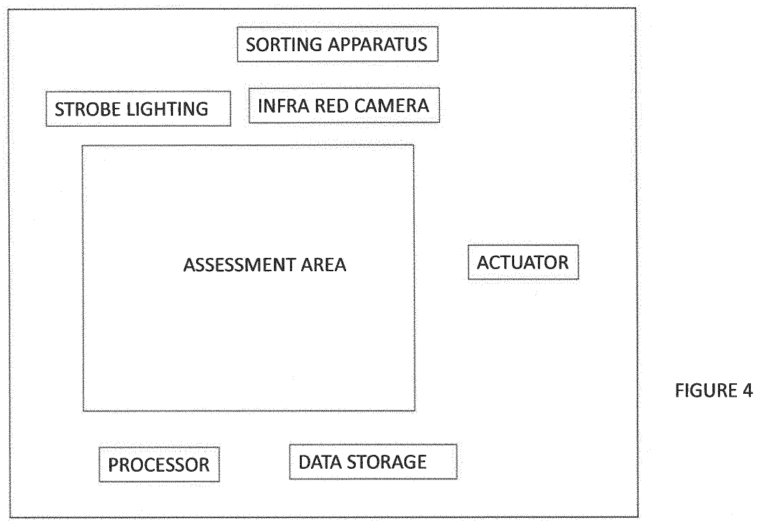

Whilst the preceding specific features envisaged may be appropriate for certain applications, FIG. 4 illustrates a more general embodiment of a sorting apparatus in accordance with an embodiment of the invention comprising a processor, data storage, an assessment area, strobe lighting, and an infra-red camera.

We claim:

1. A method of handling tubers comprising the steps:
providing a batch of in tubers;
providing at least one camera for generating images of the individual tubers in the batch of tuber and/or images of the batch of individual tubers;
providing at least one conveyor for displacing said tubers relative to said camera;
providing a processor communicating with the at least one camera for receiving images generated by the at least one camera;
processing, with the processor, images obtained from said at least one camera to determine at least one value representative of said tubers' diameter and at least one value representative of said tubers' length;
providing an actuator for directing tubers having, a determined value below a pre-determined diameter d₁ towards a first category of tubers and directing tubers having a determined value above said pre-determined diameter d₁ for further processing;
further processing said tubers by either accepting said tubers into a target category when said tubers' length is above a variable length Lₓ or directing said tubers for further processing when said tubers' length is below said variable length Lₓ;
assessing the average length of the batch of tubers and dynamically adjusting, with the processor, said variable length Lₓ; and
whereby a pre-determined average length L₁ of tubers for a pre-determined number of tubers may be maintained for said target category.

2. A method of handling tubers according to claim 1, and further comprising:
the step of assessing said tubers which are not selected for said target category against a pre-determined length L₂ and directing said tubers either to a second category when said tubers are below said pre-determined length L₂ or to said first category when said tubers are above said pre-determined length L₂.

3. (canceled)

4. (canceled)

5. A method according to claim 2, wherein said variable length is adjusted by the processor after a batch of tubers has been assessed; whereby the average length of a sequence of batches may be maintained for said target category of tubers.

6. (canceled)

7. A method according to claim 1, and further comprising:
a processor for assessing said tubers which are not selected for said target category against a pre-determined length L₂; and
an actuator configured to direct said tubers either to a second category when said tubers are above said pre-determined length L₂ or to said first category when said tubers are above said pre-determined length L₂.

8. (canceled)

9. (canceled)

10. (canceled)

11. (canceled)

12. A method of handling a batch of tubers of claim 1 and further comprising the steps of:
providing a database of predetermined characteristics accessible by the processor;
determining a number of pixels of a predetermined characteristic; and
determining a percentage of the total number of pixels in an image of a tuber which corresponds to said predetermined characteristic.

13. A method according to claim 12, and further comprising the step of:
obtaining a plurality of images of each individual tuber with the at least one camera whilst said tuber is being rotated, on the at least one conveyor; and
recording the highest percentage of the total number of pixels in an image which corresponds to said predetermined characteristic.

14. A method according to claim 12, wherein said predetermined characteristic includes a colour representative of one or more of the following: green, spots, discolouration, and rot.

15. A method according to claim 12, wherein said predetermined characteristic includes a colour in combination with a shape of an area representative of one or more of the following: a green shape, mechanical damage, a scab, a crack, a black dot, a black scurf, a silver scurf, a skin spot.

16. (canceled)

17. (canceled)

18. (canceled)

19. A system for assessing a batch of tubers comprising:
at least one camera configured obtain a plurality of images of each individual tuber in the batch of tubers while the tubers are being rotated;
at least one conveyor for displacing said tubers relative to said camera;
a processor for obtaining images of said tubers from said camera and determining a number of pixels of a predetermined characteristic;
said processor determines a percentage of the total number of pixels in an image of said tuber which corresponds to said predetermined characteristic; and
data storage, in communication with the processor, recording said numbers and percentages obtained for a batch of tubers.

20. (canceled)

21. (canceled)

22. (canceled)

23. (canceled)

24. (canceled)

25. (canceled)

26. (canceled)

27. A system according to claim 19 and further comprising:
an assessment area; and
a single access portal through which a batch of tubers sequentially enters and exits said assessment area.

28. A system for assessing a batch tubers of claim 19, and further comprising:
at least one conveyor for moving said tubers relative to said camera;
a database of predetermined characteristics of tubers;
a processor for obtaining a plurality of images of said tubers from said at least one camera and determining a number of pixels in the plurality of obtained images of at least one predetermined characteristic of tubers;
said processor being configured to determine a percentage of the total number of pixels of said tuber in an image which corresponds to said predetermined characteristic;
a plurality of discharge routes communicating with the at least one conveyor; and
at least one actuator for individually directing a tuber to a determined discharge route dependent upon its determined percentage.

29. A system according to claim 28, wherein said actuator comprises one or more actuatable fingers for individually directing a tuber to a determined discharge route.

30. (canceled)

31. A system according to claim 28 and further comprising strobe lighting that is synchronized with said at least one camera; and
said lighting is in the visible and invisible spectrum.

32. (canceled)

33. (canceled)

34. (canceled)

35. (canceled)

36. A system according to claim 31 and, wherein said predetermined characteristic is selected from one or more of the following: rot, skin discolouration, shape, texture, green colour, colour of the ends of the said tubers, spot, cut, crack, length, diameter and/or square mesh.
